(19) United States
(12) Patent Application Publication
(10) Pub. No.: US 2002/0100159 A1
(43) Pub. Date: Aug. 1, 2002

(54) Flexible assembly cell

(76) Inventors: Joseph P. Swartz, Clinton Township, MI (US); Michael D. Turner, Rochester Hills, MI (US)

Correspondence Address: Harness Dickey & Pierce P.L.C., P. O. Box 828, Bloomfield Hills, MI, 48303, US

(21) Appl. No.: 09/771,781

(22) Filed: Jan. 29, 2001

(51) Int. Cl. B23P 11/00; B23P 21/00

(52) U.S. Cl. 29/430; 29/783; 29/785

(57) ABSTRACT

An assembly apparatus for producing a plurality of articles that are each assembled from a plurality of workpiece components through a predetermined sequence of assembly steps. The assembly apparatus includes a first assembly cell, a second assembly cell and a conveyance mechanism. The first assembly cell has a first tooling set with a plurality of tooling components. The first tooling set is configured to perform the predetermined sequence of assembly steps. The first assembly cell employs the first tooling set to produce at least a first quantity of the articles. The second assembly cell has a second tooling set which is identical to the first tooling set. The second assembly cell employs the second tooling set to produce at least a second quantity of the articles. The conveyance mechanism is coupled to the first and second assembly cells and conveys the articles produced in the first and second assembly cells to a discharge point. A method for assembling an article is also provided.

### TECHNICAL FIELD

The present invention relates generally to devices for the assembly of commercially produced articles and more particularly to a device for use in the high volume assembly of commercial articles wherein the assembly operations are largely performed in a plurality of similarly configured assembly cells.

### BACKGROUND OF THE INVENTION

### BACKGROUND ART

Modernly, the various known methods for high volume assembly have typically broken the entire assembly task into a plurality of work elements that are allocated to various work stations throughout a main assembly line. Dedicated high-volume tooling is normally employed to perform each of the various work elements. Although configuration of an assembly line in this manner has demonstrated the capability for extremely efficient production in a relatively small space, several drawbacks have been noted.

One such drawback concerns situations in which the rate of production is scheduled to ramp up from a relatively low rate of production to a relatively high rate of production over a relatively long period of time. This type of situation is challenging in that it is highly desirable to delay the procurement of high-volume tooling until production rates have ramped up to significant levels since high-volume tooling is typically expensive. Furthermore, the dedicated high-volume tooling can consume a relatively large amount of floor space which tends to be difficult to justify at relatively low production rates.

It is also highly desirable that any tooling that is procured for production at relatively low volumes be put to productive use during the stages of relatively high volume production. Unfortunately, this is often times not possible, as in the case when a manually operated low-volume station is entirely replaced by a multi-spindle automatically operated high volume station. In such situations, the tooling that is employed for the relatively low-volume stage of production is typically scrapped or stripped of components that are specific to the article that is being produced and sold as excess equipment. Since the low-volume stations are often times not integrated into the high volume assembly line, and since the engineering for the low-volume stations is often significantly different from that of the high-volume station, it is highly desirable to avoid multiple iterations of tooling that are procured solely to accommodate changes in the rate of production.

Another drawback of the modern high-volume assembly lines is their use of many application-specific tools that are uniquely configured to facilitate the assembly of a specific article on a specific assembly line. The uniqueness of the application-specific tools, while facilitating high-volume production, are extremely expensive due to the amount of engineering that is required in their design, fabrication and testing. Even after these tools have been tested and run-off to demonstrate their capacity and capability, the fact that they are so unique leads to difficulties with their maintenance, particularly where large numbers of unique tools are employed to assemble a relatively complex article, such as a cylinder head for an internal combustion engine. The difficulties that are routinely encountered with the maintenance of such unique tools concerns the need to stock unique service parts and the inability of the persons that are responsible for maintaining the equipment to be intimately familiar with the nuances of each application-specific tool.

Perhaps the most significant drawback associated with the known types of assembly lines relates to the synchronous nature of these processes. The occurrence of a breakdown of any station within the confines of the assembly line prevents the flow of work to subsequent work stations, causing the assembly line to terminate production. In the past, this concern had been addressed through the use of banks of semi-finished articles between the various work stations. Each bank would permit the down-stream portion of the assembly line to continue to operate at their fully production capacity until the bank was stripped out. Modern manufacturing techniques have taught against the use of banks due to their negative impact on inventory turns, cycle time and quality.

One alternative that has been suggested is the employment of various manual back-up/repair stations. Each of these stations is typically connected to a main portion of an assembly line through a spur conveyor to permit all or a portion of the work flow to be diverted from an application-specific tool. These manual back-up stations are typically very costly and tend to consume large amounts of floor space. Furthermore, as defect rates can vary according to the type of tooling that is employed to perform a specific operation, the use of a second, differently configured tool to perform an assembly operation may raise a quality control issue that had not existed with the application-specific tool.

Accordingly, there remains a need in the art for an assembly device and technique that is able to accommodate significant variations in the rate of production in a cost efficient manner that minimizes or eliminates the use of unique application-specific tools and permits production to continue without the use of banks despite a breakdown at one or more of the work stations.

### SUMMARY OF THE INVENTION

In one preferred form, the present invention provides an assembly apparatus for producing a plurality of articles that are each assembled from a plurality of workpiece components through a predetermined sequence of assembly steps. The assembly apparatus includes a first assembly cell, a second assembly cell and a conveyance mechanism. The first assembly cell has a first tooling set with a plurality of tooling components. The first tooling set is configured to perform the predetermined sequence of assembly steps. The first assembly cell employs the first tooling set to produce at least a first quantity of the articles. The second assembly cell has a second tooling set which is identical to the first tooling set. The second assembly cell employs the second tooling set to produce at least a second quantity of the articles. The conveyance mechanism is coupled to the first and second assembly cells and conveys the articles produced in the first and second assembly cells to a discharge point.

In another preferred form, the present invention provides a method for assembling a plurality of workpiece components into a plurality of articles through a predetermined sequence of assembly steps. The method includes the steps of: providing a plurality of tooling sets, each of tooling sets having a plurality of tooling components; providing first and second assembly cells; equipping the first assembly cell with a first one of the plurality of tooling sets to permit the first assembly cell to perform the predetermined sequence of assembly steps; equipping the second assembly cell with a second one of the plurality of tooling sets to permit the second assembly cell to perform the predetermined sequence of assembly steps; and allocating at least a portion of a production schedule between the first and second assembly cells.

### BRIEF DESCRIPTION OF THE DRAWINGS

Additional advantages and features of the present invention will become apparent from the subsequent description and the appended claims, taken in conjunction with the accompanying drawings, wherein:

FIG. 1 is a plan view of an assembly apparatus constructed in accordance with the teachings of the present invention;

FIG. 2 is a cross-sectional view of an exemplary cylinder head assembly;

FIG. 3 is a plan view similar to that of FIG. 1 but illustrating an assembly apparatus constructed in accordance with an alternate embodiment of the present invention;

FIG. 4 is a plan view of an assembly apparatus constructed in accordance with the teachings of a second alternate embodiment of the present invention; and

FIG. 5 is a plan view similar to that of FIG. 4 but illustrating the use of a rotary indexable table for translating semi-finished articles through the assembly cell.

### DETAILED DESCRIPTION OF THE PREFERRED EMBODIMENT

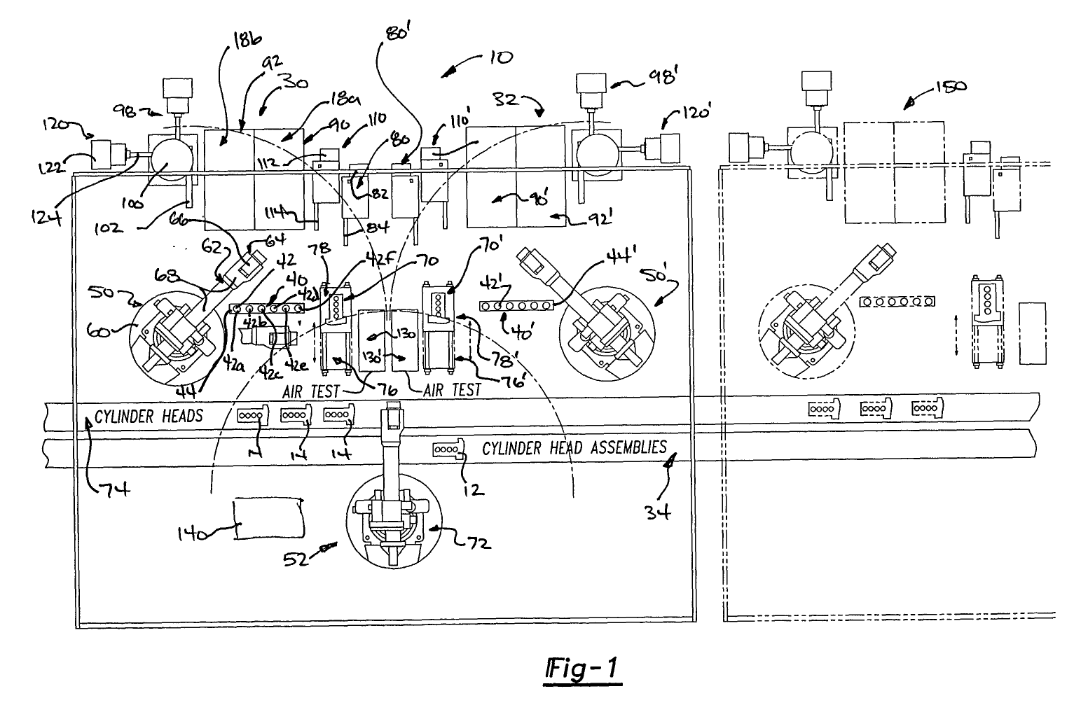

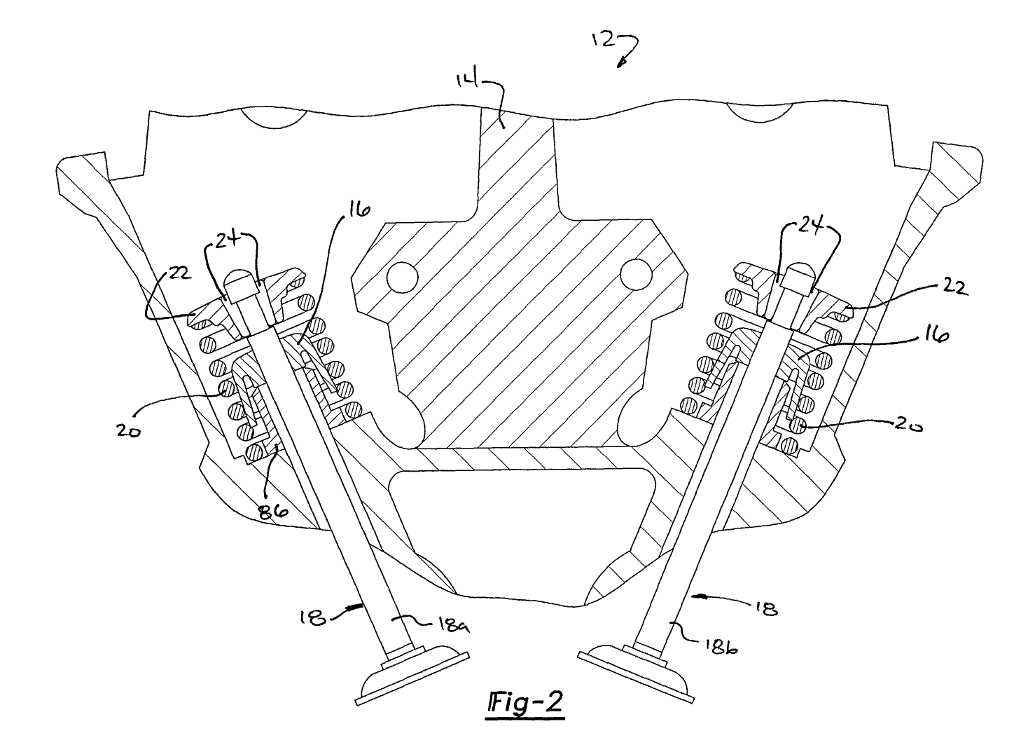

With reference to FIG. 1 of the drawings, an assembly apparatus constructed and operated in accordance with the teachings of the present is generally indicated by reference numeral 10. In the particular embodiment illustrated, the assembly apparatus 10 is operable for assembling a plurality of workpiece components into a cylinder head assembly 12 which is illustrated in greater detail in FIG. 2. The plurality of workpiece components are shown to include a cylinder head 14, a plurality of valve seals 16, a plurality of valves 18, a plurality of springs 20, a plurality of spring caps 22 and a plurality of keepers 24. Those skilled in the art will understand that the reference to a cylinder head assembly and its associated workpiece components is exemplary and not intended to limit the scope of the present invention in any manner.

Returning to FIG. 1, the assembly apparatus 10 is illustrated to include a first assembly cell 30, a second assembly cell 32 and a conveyance mechanism 34. As the first and second assembly cells 30 and 32 are identically equipped, only the first assembly cell 30 will be discussed in detail. Similar or corresponding elements of the second assembly cell 32 are identified by the same reference numerals as used to describe the first assembly cell 30, except that the reference numerals are primed.

The first assembly cell 30 includes a tooling set 40 having a plurality of tooling components 42 which are employed in a predetermined sequence of assembly steps for assembling cylinder head assemblies 12. In the particular example provided, the tooling set 40 includes a seal insertion tool 42a, a valve insertion tool 42b, a spring insertion tool 42c, a spring cap insertion tool 42d and a key-up tool 42e. The tooling set 40 is housed in a tool changer mechanism 44, which will be discussed in further detail, below.

The first assembly cell 30 also shown to include a programmable robot 50 and a transfer mechanism 52. The programmable robot 50 is a commercially available multi-axis assembly robot, such as an IRB 6400R robot marketed by ABB Flexible Automation Inc. of Auburn Hills, Mich. having a 2.8 meter arm with a 200 kilogram payload. The programmable robot 50 is illustrated to include a base structure 60, an arm assembly 62 and an end effector 64. The base structure 60 is selectively pivotable about a generally vertical axis. The arm assembly 62 is coupled to the base structure 60 and in the particular example provided, includes a wrist assembly 66 and a plurality of arm members 68 which pivotably couple the wrist assembly 66 to the base structure 60. The wrist assembly 66 is coupled to the distal end of one of the arm members 68 and permits the end effector 64 to be selectively rotated about the longitudinal axis of that arm member 68. The end effector 64 is configured to selectively engage each of the tooling components 42 that are housed in the tool changer mechanism 44, thereby permitting the programmable robot 50 to perform the assembly steps that are associated with these tools.

The transfer mechanism 52 is operable for loading at least one of the workpiece components into the first assembly cell 30 and is also preferably operable for unloading finished articles (i.e., cylinder head assemblies 12) from the first assembly cell 30. In the particular embodiment illustrated, the transfer mechanism 52 includes a slide table 70 and a second programmable robot 72. The second programmable robot 72 is operable for picking a workpiece component, such as a cylinder head 14, from a predetermined location, such as a skid or a conveyor 74, and loading it onto the load area 76 of the slide table 70, which is located within a predetermined area of the second programmable robot's 72 reach and which is indicated in phantom about the second programmable robot 72. The slide table 70 is operable for conveying cylinder heads 14 into a predetermined work area 78 within the programmable robot's 50 reach, which is indicated in phantom about the programmable robot 50.

In the particular embodiment illustrated, the second programmable robot 72 feeds cylinder heads 14 onto the slide tables 70 and 70′ of the first and second assembly cells 30 and 32, respectively, when one of the slide tables 70 and 70′ is empty. Each of the slide tables 70 and 70′ then shuttle a loaded cylinder head 14 from the load area within the reach of the second programmable robot 72 to the work area 78 within the reach of the programmable robot of its associated assembly cell. As the first and second assembly cells 30 and 32 are similarly equipped and operated, only the operation of the first assembly cell 30 will be discussed in further detail.

The cylinder head 14 that is located in the work area 78 within the first assembly cell 30 is positioned in a predetermined location by the slide table 70. The programmable robot 50 selects the seal insertion tool 42a from the tool changer mechanism 44, extends the arm assembly 62 to place the seal insertion tool 42a in position to pick a set of valve seals 16 from a valve seal material transfer system 80. The valve seal material transfer system 80 is a transfer system of the type that is well known in the art and need not be discussed in significant detail herein. Briefly, the valve seal material transfer system 80 is operable for translating bulk-loaded, randomly-oriented valve seals 16 from a hopper 82 to a delivery chute 84 wherein a set of valve seals 16 is oriented and spaced in a predetermined manner. Once the set of valve seals 16 has been loaded into the seal insertion tool 42a, the programmable robot 50 then moves the seal insertion tool 42a proximate the cylinder head 14 and performs a valve seal installation operation wherein each of the valve seals 16 is pressed onto an associated part of the cylinder head 14 (i.e., onto an associated one of the valve guides 86 that are illustrated in FIG. 2). The programmable robot 50 then returns the seal insertion tool 42b to the tool changer mechanism 44 and selects the valve insertion tool 42b. Simultaneous with this exchange of tooling, the cylinder head 14 is rotated on the slide table 70, preferably more than 90 degrees, to facilitate the installation of the valves 18.

The programmable robot 50 next extends the arm assembly 62 to place the valve insertion tool 42b in position to pick a set of exhaust valves 18a from an exhaust valve transfer system 90. The exhaust valve transfer system 90 is a transfer system of the type that is well known in the art and need not be discussed in significant detail herein. Briefly, the exhaust valve transfer system 90 is operable for translating bulk-loaded, pre-oriented exhaust valves 18a delivery site that is accessible by the programmable robot 50. Once the set of exhaust valves 18a has been loaded into the valve insertion tool 42b, the programmable robot 50 then moves the valve insertion tool 42b proximate the underside of the cylinder head 14 and performs an exhaust valve installation operation wherein each of the exhaust valves 18a is inserted through an associated exhaust port formed into the cylinder head 14 such that its stem extends through an associated one of the valve seals 16.

The programmable robot 50 then extends the arm assembly 62 to place the valve insertion tool 42b in position to pick a set of intake valves 18b from an intake valve transfer system 92. The intake valve transfer system 92 is identical to the exhaust valve transfer system and need not be discussed in significant detail herein. Once the set of intake valves 18b has been loaded into the valve insertion tool 42b, the programmable robot 50 then moves the valve insertion tool 42b proximate the underside of the cylinder head 14 and performs an intake valve installation operation wherein each of the intake valves 18b is inserted through an associated intake port formed into the cylinder head 14 such that its stem extends through an associated one of the valve seals 16. The programmable robot 50 then returns the valve insertion tool 42b to the tool changer mechanism 44 and selects the spring insertion tool 42c. Simultaneous with this exchange of tooling, the cylinder head 14 is rotated on the slide table 70 to its original position. As will be understood by those skilled in the art, a plate or similar mechanism preferably contacts the exhaust and intake valves 18a and 18b to maintain the valves against the underside of the cylinder head 14 so as to facilitate the remainder of the assembly sequence.

The programmable robot 50 next extends the arm assembly 62 to place the spring insertion tool 42c in position to pick a set of springs 20 from a spring material transfer system 98. The spring material transfer system 98 is a transfer system of the type that is well known in the art and need not be discussed in significant detail herein. Briefly, the spring material transfer system 98 is operable for translating bulk-loaded, randomly-oriented springs 20 from a hopper 100 to a delivery chute 102 wherein a set of springs 20 is oriented and spaced in a predetermined manner. Once the set of springs 20 has been loaded into the spring insertion tool 42c, the programmable robot 50 then moves the spring insertion tool 42c proximate the cylinder head 14 and performs a spring installation operation wherein each of the springs 20 is placed over and around an associated stem of one of the exhaust and intake valves 18a and 18b. The programmable robot 50 then returns the spring insertion tool 42c to the tool changer mechanism 44 and selects the spring cap insertion tool 42d.

The programmable robot 50 next extends the arm assembly 62 to place the spring cap insertion tool 42d in position to pick a set of spring caps 22 from a spring cap material transfer system 110. The spring cap material transfer system 110 is a transfer system of the type that is well known in the art and need not be discussed in significant detail herein. Briefly, the spring cap material transfer system 110 is operable for translating bulk-loaded, randomly-oriented spring caps 22 from a hopper 112 to a delivery chute 114 wherein a set of spring caps 22 is oriented and spaced in a predetermined manner. Once the set of spring caps 22 has been loaded into the spring cap insertion tool 42d, the programmable robot 50 then moves the spring cap insertion tool 42d proximate the cylinder head 14 and performs a spring cap installation operation wherein each of the spring caps 22 is placed over an associated one of the valves 18 and springs 20. The programmable robot 50 then returns the spring cap insertion tool 42d to the tool changer mechanism 44 and selects the key-up tool 42e.

The programmable robot 50 extends the arm assembly 62 to place the key-up tool 42e in position to pick a set of valve keys or keepers 24 from a valve key material transfer system 120. The valve key material transfer system 120 is a transfer system of the type that is well known in the art and need not be discussed in significant detail herein. Briefly, the valve key material transfer system 120 is operable for translating bulk-loaded, randomly oriented keepers 24 from a hopper 122 to a delivery chute 124 wherein a set of keepers 24 is oriented and spaced in a predetermined manner. Once the set of keepers 24 has been loaded into the key-up tool 42e, the programmable robot 50 moves the key-up tool 42e proximate the cylinder head 14 and performs a valve key installation operation wherein a force is exerted by the programmable robot 50 to compress one or more of springs 20 to permit an associated pair of keepers 24 to be introduced to the spring cap 22 below a key groove formed in the stem of the valve 18. The programmable robot 50 then reduces the force that is exerted onto the spring(s) 20, either partially or fully, to cause each of the springs 20 to push their associated spring cap 22 and keepers 24 in a upward direction to permit the keepers 24 to engage the key groove. The key-up tool 42e preferably includes a key-checking mechanism to automatically determine whether all of the keepers 24 have been properly installed. Key-checking mechanisms, such as those which employ lasers, machine vision and ultrasonics, that verify not only the presence of the pair of keepers 24 at each of the valves 18 but also that the keepers 24 have been installed to the proper height (i.e., fully seated in the spring cap 22 and fully engaging the key groove) are well known in the art and need not be discussed in detail herein.

Preferably, the tooling set 40 also includes an air test unit 130 and an air test tool 42f. The programmable robot 50 next returns the key-up tool 42e to the tool changer mechanism 44, selects the air test tool 42f and couples the air test tool 42f to the cylinder head 14. The air test unit 130 is preferably an automatically-actuated commercially available air test unit that is employed to air test the cylinder head assembly 12 to verify that air cannot pass through the valves 18 into the associated exhaust and intake ports while the valves are in the closed position against the underside of the cylinder head 14. Regardless of the results of the air test, the programmable robot 50 removes the air test tool 42f from the cylinder head 14, returns the air test tool 42f to the tool changer mechanism 44 and selects the seal insertion tooling 42a in preparation for the next cylinder head 14 that is to be assembled. The slide table 70 indexes the cylinder head assembly 12 from the work area 78 to the load area 76 where it is relocated by the second programmable robot 72 in a manner that is dependent upon the results of the air test. Those cylinder head assemblies 12 that have successfully passed the air test are loaded onto the conveyance mechanism 34 to permit these cylinder head assemblies 12 to be conveyed to a predetermined discharge point. Typically, the discharge point for the cylinder head assemblies 12 is a point proximate an engine assembly line that presents the cylinder head assemblies 12 to a heavy-duty assembly robot such that the cylinder head assemblies 12 can be picked up and placed onto partially assembled cylinder blocks as part of an engine assembly operation. Those cylinder head assemblies 12 that have not successfully passed the air test are loaded to an off-line area, in this case a pallet 140, to permit these cylinder head assemblies 12 to be inspected and repaired or salvaged as necessary.

The configuration and operation of the assembly apparatus 10 in the manner described above is highly advantageous over conventional assembly lines that are arranged with a plurality of work stations that are connected in series. One of the most significant advantages is that because the first and second assembly cells 30 and 32 are similarly equipped and identically operated, break-downs that occur in one assembly cell will not effect the production of the other assembly cell. Accordingly, the assembly apparatus 10 can continue production even after a serious breakdown has occurred in one assembly cell, albeit at a lower total capacity.

Another set of advantages relates to the fact that the first and second assembly cells 30 and 32 employ identical tooling components 42 which are relatively simple as compared to the application-specific, high-volume tools that would be employed on a conventional assembly line. Because the tooling components 42 tend to be relatively simple in their design and operation, they tend to be relatively inexpensive and highly reliable. Furthermore, as multiple tooling sets 40 are employed in the assembly apparatus 10, the procurement of additional tooling sets 40 (i.e., those tooling sets in excess of a first tooling set) may be procured relatively inexpensively, particularly if multiple tooling sets 40 are procured simultaneously. In this regard, the engineering for each tooling set 40 is identical and the costs for this effort need only be incurred for the design and testing of a first one of the tooling sets 40. When multiple tooling sets 40 are procured simultaneously, economies can be realized by amortizing various fixed costs, such as machine tool set-up, over several tooling sets 40 to thereby reduce the total cost of the tooling sets 40.

The relatively simple and flexible structure of the assembly apparatus 10 is also of significant benefit. Dramatic reductions in the lead time that is associated with the design, fabrication and qualification of an assembly line, as compared to conventional assembly lines, are possible due to the fact that the assembly apparatus 10 employs relatively simple tooling components 42 and commercially available components, such as programmable robots 50. Furthermore, because the assembly apparatus 10 employs numerous commercially available components whose useful life typically exceeds the life cycle of the article that is being produced, these components may be easily reused in another assembly apparatus 10 that is configured for the assembly of a different article.

Since the assembly apparatus 10 employs numerous cells which can be oriented in any manner, the assembly apparatus 10 is extremely flexible, permitting it to be arranged or re-arranged in different configurations with relatively little engineering. The use of multiple assembly cells is also advantageous in that the production capacity of the assembly apparatus 10 can be easily tailored to a desired level through the introduction or removal of assembly cells to thereby facilitate to the efficient use of monetary resources. For example, the addition of a third assembly cell 150, illustrated in phantom in FIG. 1, permits the production capacity of the assembly apparatus 10 to be increased by 50 percent at a later date when this additional capacity is required.

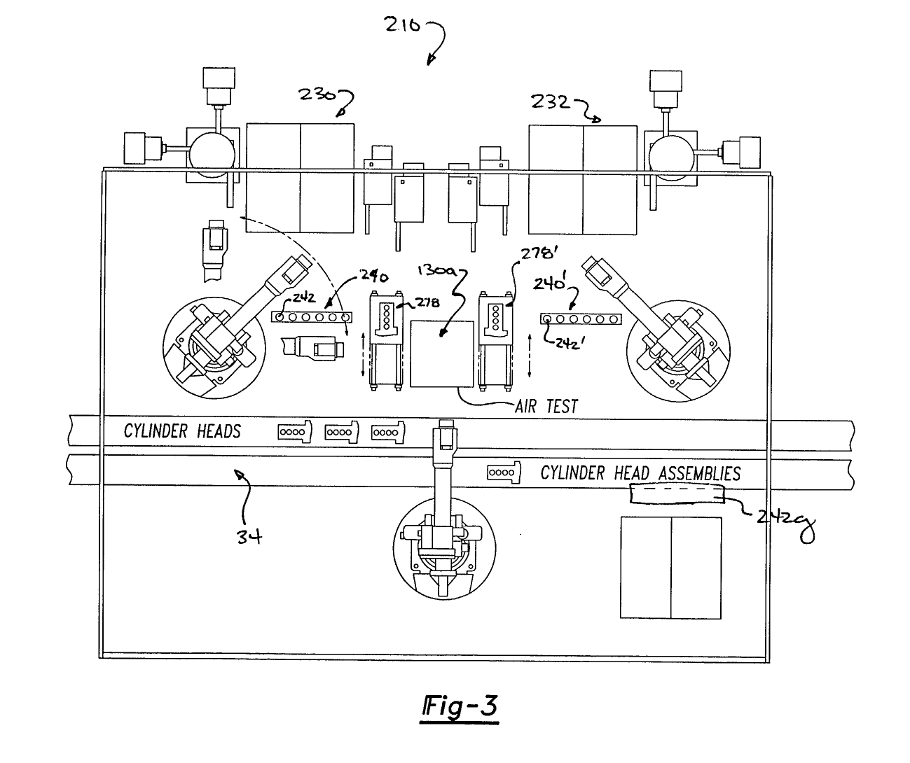

While the assembly apparatus 10 has been described thus far as including a plurality of assembly cells that have a single programmable robot and distinct tooling sets for assembling a single article at a time, those skilled in the art will appreciate that the invention, in its broader aspects, may be constructed somewhat differently. For example, the assembly cells may be equipped with tooling sets 240 that share one or more tooling components 242 as illustrated in FIG. 3. In this arrangement, each of the tooling sets 240 is generally identical to the tooling set 40, except for the addition of a plug installation tool 242g and the substitution of an air test unit 130a for air test unit 130. Air test unit 130a is similar to air test unit 130, except that air test unit 130a is shared between the first and second assembly cells 230 and 232, respectively, to lower the overall cost of the assembly apparatus 210. Similarly, plug installation tool 242g, which is located on the conveyance mechanism 34, is shared between the first and second assembly cells 230 and 232. Plug installation tool 242g is preferably a highly efficient, capable and reliable tooling component, such as an automatic multi-spindle fastening tool, that permits a coolant gallery plug (not specifically shown) to be installed to the cylinder head 14 in an area that is remote from the work areas 278 and 278′ of the first and second assembly cells 230 and 232 so as to maximize their production capacity.

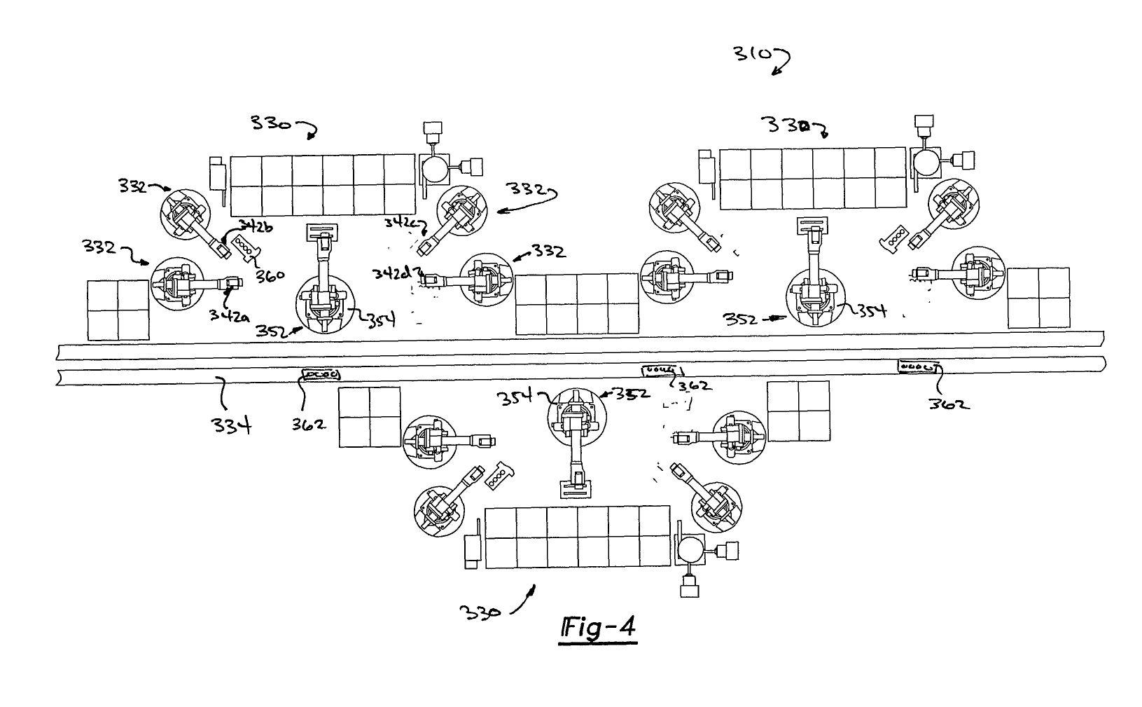

A second alternate embodiment is illustrated in FIG. 4, wherein each of the assembly cells 330 includes a plurality of programmable robots 332, with each of the programmable robots 332 being dedicated to a single one of the tooling components 342a through 342d. The transfer mechanism 352 is illustrated to be a programmable robot 354 that is dedicated to its associated assembly cell 330. The programmable robot 354 is operable for loading the assembly cell 330, indexing a workpiece component 360, such as a cylinder head, to each of the tooling components 342 and unloading an assembled article 362 to the conveyance mechanism 334. Construction of assembly apparatus 310 in this manner is advantageous in that it is more efficient since no time is lost waiting for a programmable robot to change the tooling component that it is using or pick material from a material delivery system.

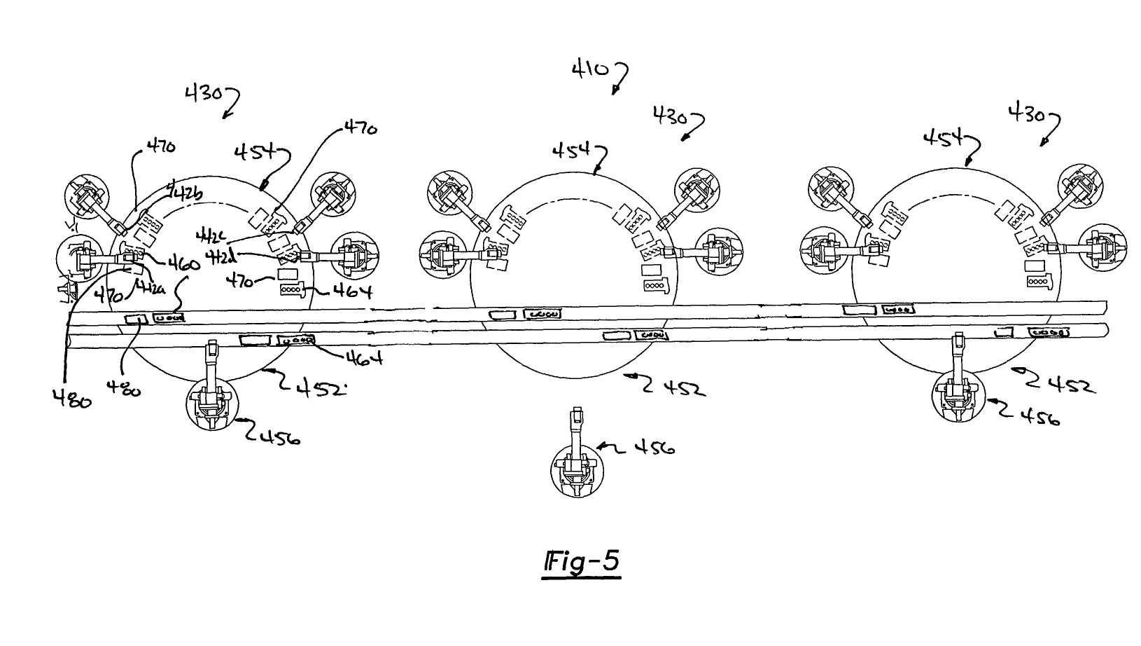

A modification of this latter concept is illustrated in FIG. 5. The assembly apparatus 410 illustrated in FIG. 5 is similar to that of FIG. 4 except that a transfer mechanism 452 has been substituted for transfer mechanism 352. Transfer mechanism 452 is shown to include a rotary indexable table 454 and a programmable robot 456. The programmable robot 456 is operable for loading a workpiece component 460 to and unloading assembled articles 464 from the rotary indexable table 454. Rotary indexable tables are well known in the art and need not be discussed in detail herein. Briefly, the rotary indexable table 454 includes a plurality of work stations 470 which can be rotated to predetermined positions beneath each of the tooling components 442a through 442d.

In the particular embodiment illustrated, the programmable robot 456 loads both a workpiece component 460 and an assembly kit 480 onto the rotary indexable table 454 at a load station. Rotation of the rotary indexable table 454 thereby translates the workpiece component 460 to the next tooling component 442 that is to be used in the assembly sequence and also conveys the material that is to be used in the particular assembly operation. In the operation of assembly apparatus 410, each of the tooling components 442 may be used simultaneously on several different workpiece components 460, each of which being located at a different work station 470, to thereby maximize the production capacity of the assembly cell 430.

While the invention has been described in the specification and illustrated in the drawings with reference to a preferred embodiment, it will be understood by those skilled in the art that various changes may be made and equivalents may be substituted for elements thereof without departing from the scope of the invention as defined in the claims. In addition, many modifications may be made to adapt a particular situation or material to the teachings of the invention without departing from the essential scope thereof. Therefore, it is intended that the invention not be limited to the particular embodiment illustrated by the drawings and described in the specification as the best mode presently contemplated for carrying out this invention, but that the invention will include any embodiments falling within the foregoing description and the appended claims.

What is claimed is:

1. An assembly apparatus for producing a plurality of articles, each of the articles being assembled from a plurality of workpiece components through a predetermined sequence of assembly steps, the assembly apparatus comprising:
a first assembly cell having a first tooling set with a plurality of tooling components, the first tooling set being operable for performing the predetermined sequence of assembly steps, the first assembly cell producing at least a first quantity of the articles;
a second assembly cell having a second tooling set, the second tooling set being identical to the first tooling set, the second assembly cell producing at least a second quantity of the articles; and
a conveyance mechanism for conveying the articles produced in the first and second assembly cells to a discharge point.

2. The assembly apparatus of claim 1, wherein each of the first and second assembly cells includes a programmable robot for performing at least a portion of the predetermined sequence of assembly steps.

3. The assembly apparatus of claim 2, wherein the programmable robot includes a tool changer mechanism for selectively engaging and disengaging at least two of the plurality of tooling components.

4. The assembly apparatus of claim 1, wherein the assembly apparatus further includes a transfer mechanism for loading a first one of the workpiece components into each of the first and second assembly cells.

5. The assembly apparatus of claim 4, wherein the transfer mechanism is further operable for transferring the articles produced in the first and second assembly cells to the conveyance mechanism.

6. The assembly apparatus of claim 5, wherein the conveyance mechanism is a slide table.

7. The assembly apparatus of claim 1, wherein each of the tooling components in each of the first and second tooling sets is coupled to a programmable robot.

8. The assembly apparatus of claim 7, wherein a second conveyance mechanism is employed in each of the first and second assembly cells to transport one of the workpiece components between each of the tooling components.

9. The assembly apparatus of claim 8, wherein the second conveyance mechanism is a programmable robot.

10. The assembly apparatus of claim 8, wherein the second conveyance mechanism is an indexable rotary table.

11. The assembly apparatus of claim 1, wherein each of the first and second assembly cells includes a supplemental conveyance system for conveying an assembly kit to an associated one of the first and second assembly cells.

12. The assembly apparatus of claim 1, wherein the article is a cylinder head assembly.

13. The assembly apparatus of claim 12, wherein each of the first and second tooling sets includes a seal insertion tool, a valve insertion tool, a spring insertion tool and a key-up tool.

14. The assembly apparatus of claim 1, wherein the first and second tooling sets share at least one tooling component.

15. The assembly apparatus of claim 14, wherein the at least one shared tooling component includes a leak test device.

16. The assembly apparatus of claim 14, wherein the at least one shared tooling component is located on the conveyance mechanism.

17. A method for assembling a plurality of workpiece components into a plurality of articles through a predetermined sequence of assembly steps, the method comprising the steps of:
providing a plurality of tooling sets, each of tooling sets having a plurality of tooling components;
providing first and second assembly cells;
equipping the first assembly cell with a first one of the plurality of tooling sets to permit the first assembly cell to perform the predetermined sequence of assembly steps;
equipping the second assembly cell with a second one of the plurality of tooling sets to permit the second assembly cell to perform the predetermined sequence of assembly steps; and
allocating at least a portion of a production schedule between the first and second assembly cells.

18. The method of claim 17, further comprising the steps of:
determining a capacity of the first and second assembly cells;
determining if the capacity of the first and second assembly cells is less than a predetermined production rate; and
if the capacity of the first and second assembly cells is less than the predetermined production rate:
providing a third assembly cell;
equipping the third assembly cell with a third one of the plurality of tooling sets to permit the third assembly cell to perform the predetermined sequence of assembly steps; and
allocating at least a portion of the production schedule between the first, second and third assembly cells.
